(19) United States
(12) Patent Application Publication
(10) Pub. No.: US 2012/0286921 A1
(43) Pub. Date: Nov. 15, 2012

(54) RF COIL ASSEMBLY FOR MAGNETIC RESONANCE APPARATUS

(75) Inventors: Chunsheng WANG, Shanghai (CN); David GILDERDALE, Bovey Tracey (GB)

(73) Assignee: RENISHAW PLC, Wotton-Under-Edge (GB)

(21) Appl. No.: 13/463,219

(22) Filed: May 3, 2012

(30) Foreign Application Priority Data
May 6, 2011 (GB) 1107619.7

(51) Int. Cl. H01F 27/36

(52) U.S. Cl. 336/84 R

(57) ABSTRACT

The coil assembly includes a substrate including a first coil set and a second coil set. The first coil set includes two or more coil elements that are configured to operate at a first radio frequency and the second coil set includes one or more coil elements that are configured to operate at a second radio frequency. The substrate is a flexible substrate and radio-frequency isolation means are provided for reducing coupling between at least some of the coil elements. In one embodiment, the first coil set includes a pair of first coil elements that share a common central conductor and a second coil set that includes a pair of second coil elements that also shares the common central conductor.

The present invention relates to an RF coil assembly for magnetic resonance apparatus and in particular to an improved RF coil assembly formed on a flexible substrate.

In the magnetic resonance imaging (MRI) and magnetic resonance spectroscopy (MRS) fields it is known to provide an RF coil assembly that comprises a first RF coil that is operated at a first frequency and a second RF coil that is operated at a second frequency. For example, it is known to use a Phosphorus (31P) coil or a Carbon (13C) coil in conjunction with a Hydrogen (1H) coil where the 1H coil is used either for 1H imaging or to produce the transmit B1 field required for techniques such as spin spin decoupled magnetic resonance spectroscopy. The coil may be constructed of a pair of elements instead of a single element to permit quadrature phase driving and/or parallel imaging. In such coil assemblies, the shape and relative position of the various coils needs to be carefully configured to minimise any coupling between the different coils. Such coil assemblies therefore tend to be fabricated on highly rigid supports to ensure the required geometrical configuration of the various coils is always maintained.

In certain applications, it is desirable to provide flexible coil assemblies that can adapt to the shape of the body. It has been described previously how a butterfly shaped Hydrogen (1H) coil can be overlapped with a single loop Carbon (13C) coil on a flexible substrate. The geometrical shapes of the butterfly coil and loop coil are such that coupling between the coils is minimised, even when the substrate on which the coils are formed is flexed or distorted. It is, however, widely accepted by those skilled in the art that it not possible to increase the complexity of the coil designs of such an arrangement without altering the geometrical properties of the coils and thereby introducing unacceptable levels of coupling between the coils.

According to a first aspect of the present invention, there is provided a coil assembly for magnetic resonance apparatus, the coil assembly including a substrate comprising a first coil set and a second coil set, the first coil set including two or more coil elements that are configured to operate at a first radio frequency and the second coil set including one or more coil elements that are configured to operate at a second radio frequency, wherein the substrate is a flexible substrate and radio-frequency isolation means are provided for reducing coupling between at least some of the coil elements.

The present invention thus provides a coil assembly for use with magnetic resonance apparatus, such as magnetic resonance imaging (MRI) apparatus and/or magnetic resonance spectroscopy (MRS) apparatus. The coil assembly includes a first coil set and a second coil set that each comprise one or more coil elements. The first coil set comprises at least two coil elements that are arranged to work at a first frequency. For example, the first coil set may comprise a pair of coil elements that are tuned to operate at the Hydrogen (1H) excitation frequency. The second coil set comprises at least one coil element arranged to work at a second frequency that is different to the first frequency. For example, the second coil set may comprise a pair of coil elements that are tuned to operate at either the Carbon (13C) or Phosphorous (31P) excitation frequency. A coil assembly having such first and second coil sets may conveniently be used in any MR based technique where simultaneous transmission or reception at two different frequencies is required. For example, the coil assembly may be used for spin spin decoupling or cross polarisation applications.

The first and second coil sets are both provided on a flexible substrate. The substrate, and the coil elements carried by the substrate, may thus be deformed or flexed in use. This may, for example, be used to enable a close fit of the coil assembly around a contour of the human body. The coil assembly also comprises RF isolation means that reduce coupling (e.g. inductive coupling) between at least some, and preferably all, of the coil elements. Preferably, the RF isolation means provides the required level of isolation between the various coil elements even when the flexible substrate is bent into a variety of different configurations. This allows the coil assembly to be deformed around a patient, for example to allow 31P spin spin decoupled MR imaging of the liver or heart. Unlike previous flexible coil assemblies formed using single coil elements, the provision of a first coil set having at least two coil elements can be used to provide quadrature phase operation thereby improving the signal to noise ratio (SNR), the transmit field duty cycle and the field of view of the coil assembly. A coil assembly of the present invention thus offers improved performance compared with prior art flexible coil assemblies.

Advantageously, the first coil set comprises a pair of first coil elements. These first coil elements may be adjacent one another. Preferably, the first coil elements of the pair share a common central conductor. The first coil elements are preferably operable or operated in quadrature phase. Providing such an arrangement and operating using phase quadrature driving techniques enhances the SNR and improves the field of view compared to a coil set comprising only a single coil element.

Preferably, the second coil set comprises at least two coil elements. Advantageously, the second coil set comprises a pair of second coil elements. The second coil elements may be separate to the first coil elements. Conveniently, the second coil elements are adjacent one another. The second coil elements may share a common central conductor. Advantageously, the pair of first coil elements and the pair of second coil elements all share a common central conductor. This arrangement is particularly advantageous as the use of a central conductor or rung enables electronic components to be used to isolate the coil elements. In other words, the provision of a central rung overcomes the requirement for a geometric coil design that provides isolation of the various coil elements. This arrangement is thus particularly suited to use on flexible substrates. Conveniently, the pair of second coil elements are operable in quadrature phase.

It is preferred that the first and second coil sets substantially overlap to allow the same region of space to be imaged or analysed. Advantageously, the second coil set is located within the area of the substrate enclosed by the first coil set. The coil element(s) of the second coil set may be the same, or a different, shape to the coil elements of the first coil set. Preferably, the second coil set is located centrally within the area on the substrate encompassed by the first coil set.

Advantageously, the first coil set and the second coil set can be simultaneously operated at different radio frequencies. Preferably, the first coil set is configured to operate at Hydrogen (1H) frequencies. Advantageously, the second coil set is configured to operate at Carbon (13C) or Phosphorous (31P) frequencies. As would be appreciated by the person skilled in the art, the simultaneous use of a 1H coil with a 13C or 31P coil enables MR to be undertaken using, for example, spin spin decoupling; this can enhance the quality of information collected concerning the carbon or phosphorous distribution in the body or in a sample.

Advantageously, the first coil set can operate in a RF transmit mode. The first coil set may also, or alternatively, operate in an RF receive mode. Conveniently, the second coil set can operate in a RF transmit mode. The second coil set may also, or alternatively, operate in an RF receive mode. In other words, each of the first coil set and the second coil set can operate in a transmit and/or a receive mode as required for the particular MR application.

Conveniently, the radio-frequency isolation means reduce coupling between coil elements even when the substrate is flexed into different configurations. In other words, the radio-frequency isolation means is preferably arranged to provide the desired levels of coupling isolation even when the substrate adopts different configurations. Conveniently, the radio-frequency isolation means is an electronic RF isolation means. For example. the radio-frequency isolation means preferably does not obtain the required isolation of the coil elements purely by geometric design of those coil elements. Instead, the radio-frequency isolation means preferably includes one or more electrical components that reduce coupling effects and therefore operates even if the substrate is flexed thereby changing the relative shape and positions of the various coil elements. It is preferred that the radio-frequency isolation means provides isolation between the coils elements that exceeds −10 dB. More preferably, the isolation exceeds −15 dB. More preferably, the isolation exceeds −20 dB. Advantageously, the acceptable isolation limit is maintained when the substrate is flexed.

Preferably, the radio-frequency isolation means comprises at least one RF trap for reducing coupling between coil elements of the first coil set and the second coil set. Such an RE trap may comprise a capacitor in parallel with an inductor. An RF trap may be incorporated in the first coil set and/or in the second coil set. The RF trap may be configured to suppress any current induced at the frequency of operation of the other coil set.

Conveniently, the radio-frequency isolation means comprises a dual tuned isolation network for reducing coupling between coil elements within each of the first coil set and the second coil set. Such an arrangement is particularly advantageous when applied to a coil assembly having a common conductor that is used for each of the first and second coil sets. The dual tuned isolation network is preferably tuned to the two different frequencies of operation of the first coil set and the second coil set.

As would be understood by a person of skill in the art, any of the electronic functions described herein may be implemented using single electronic components or distributed arrays of components. The exact circuit design is a matter of design choice and should in no way be seen as limiting the scope of the present invention.

The flexible substrate may comprise any suitable flexible material. Advantageous, the flexible substrate is electrically insulating. Conveniently, the substrate comprises a plastic. Preferably, the flexible substrate comprises Kapton (a registered trademark of E.I. du Pont de Nemours and Company, Wilmington, Del., USA). The various coil elements may then be formed (e.g. using metal track) on or in the substrate. The coil elements may be formed from any conductive material. Preferably, copper tracks are used to define the coil elements.

A coil assembly of the present invention may be used for any appropriate MR related application. The coil assembly may thus include the electronic components necessary for it to interface to MR apparatus. Advantageously, the coil assembly is configured for use in, for example, spin spin decoupled MR imaging or spectroscopy. Preferably, the coil assembly is configured for scanning at least part of the torso. For example, the coil assembly may be configured for scanning the abdomen and chest. A smaller coil assembly may also be provided for scanning the heart or liver.

The present invention also extends to magnetic resonance apparatus that comprises a coil assembly of the type described above. The magnetic resonance apparatus may comprise MRI apparatus, MRS apparatus or any other apparatus based on the nuclear magnetic resonance principle.

According to a further aspect of the present invention, there is provided a coil assembly for magnetic resonance apparatus, the coil assembly comprising a substrate comprising a first coil set and a second coil set, the first coil set including two or more coil elements that are configured to operate at a first radio frequency and the second coil set including one or more coil elements that are configured to operate at a second radio frequency, wherein a non-geometric radio-frequency isolation device is provided for reducing coupling between at least some of the coil elements. The coil assembly may have any one or more of the features described above.

According to a further aspect of the present invention, there is provided a coil assembly for magnetic resonance apparatus, the coil assembly comprising a flexible substrate comprising a first coil set and a second coil set, the first coil set including one or more coil elements that are configured to operate at a first radio frequency and the second coil set including one or more coil elements that are configured to operate at a second radio frequency, wherein a non-geometric radio-frequency isolation device is provided for reducing coupling between at least some of the coil elements. The coil assembly may have any one or more of the features described above.

According to a further aspect of the present invention, there is provided a coil assembly for magnetic resonance apparatus, the coil assembly comprising a flexible substrate comprising a first coil set and a second coil set, the first coil set including two or more coil elements that are configured to operate at a first radio frequency and the second coil set including one or more coil elements that are configured to operate at a second radio frequency, wherein radio-frequency isolation apparatus is provided for reducing coupling between at least some of the coil elements. The coil assembly may have any one or more of the features described above.

The invention will now be described, by way of example only, with reference to the accompanying drawings in which:

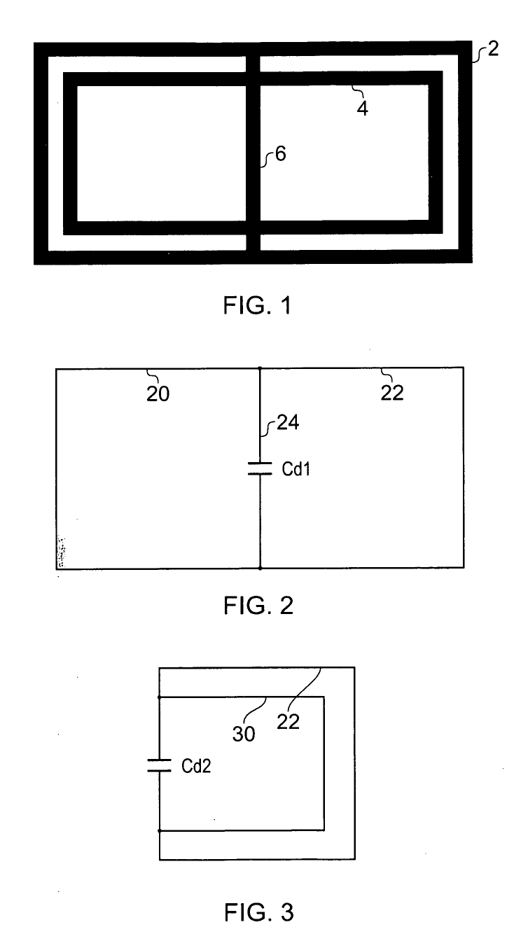

FIG. 1 illustrates the basic structure of an RF coil assembly of the present invention,

FIG. 2 shows the use of a mutual capacitance to isolate a coil pair having a common central conductor,

FIG. 3 shows the use of a mutual capacitance to isolate a concentric coil pair,

FIG. 4 illustrates four RF loops with a single capacitor,

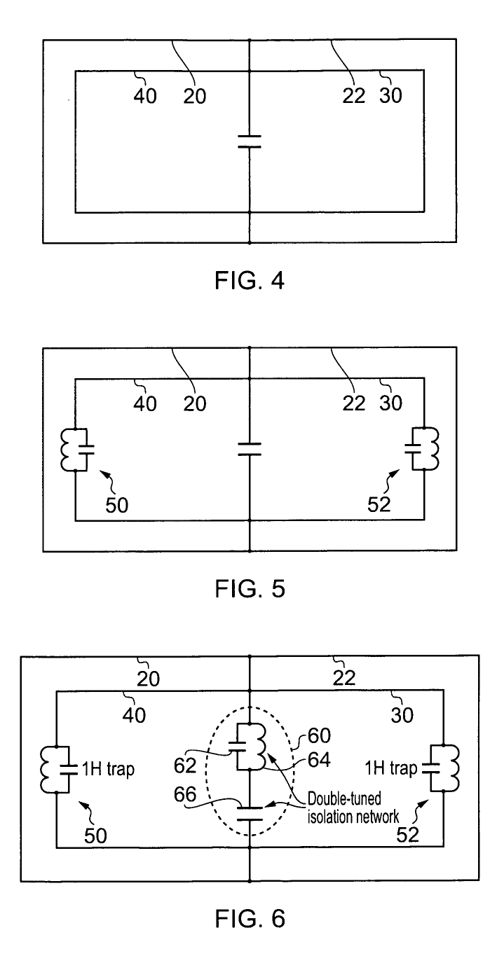

FIG. 5 shows how the addition of RF traps to the arrangement of FIG. 4 can reduce coupling between the inner and outer RF loops,

FIG. 6 shows the inclusion of a double tuned isolation network,

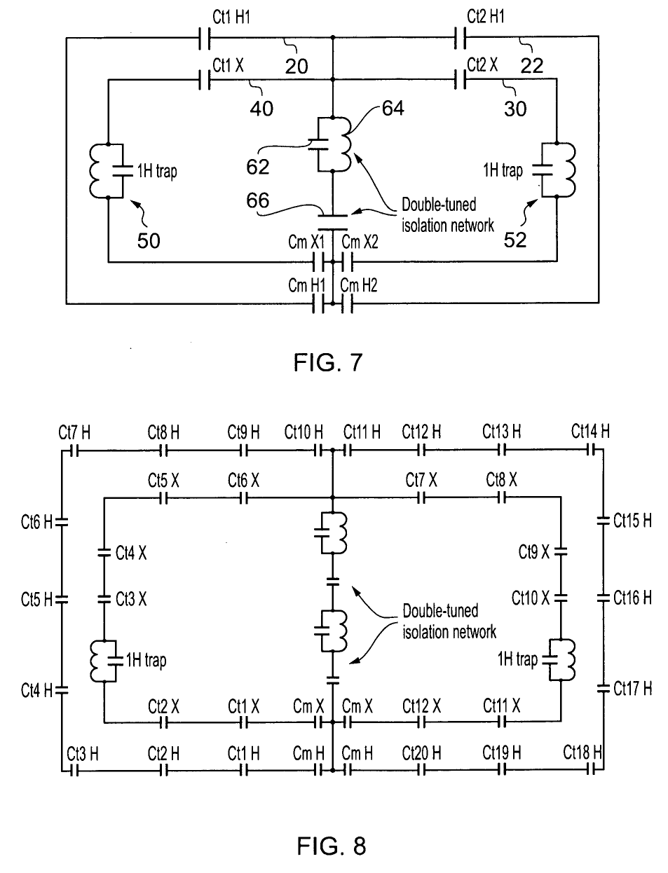

FIG. 7 shows the addition of components to the circuit of FIG. 6 to enable impedance matching to a 50 ohm transmission line,

FIG. 8 shows the circuit of FIG. 7 with a distributed capacitance,

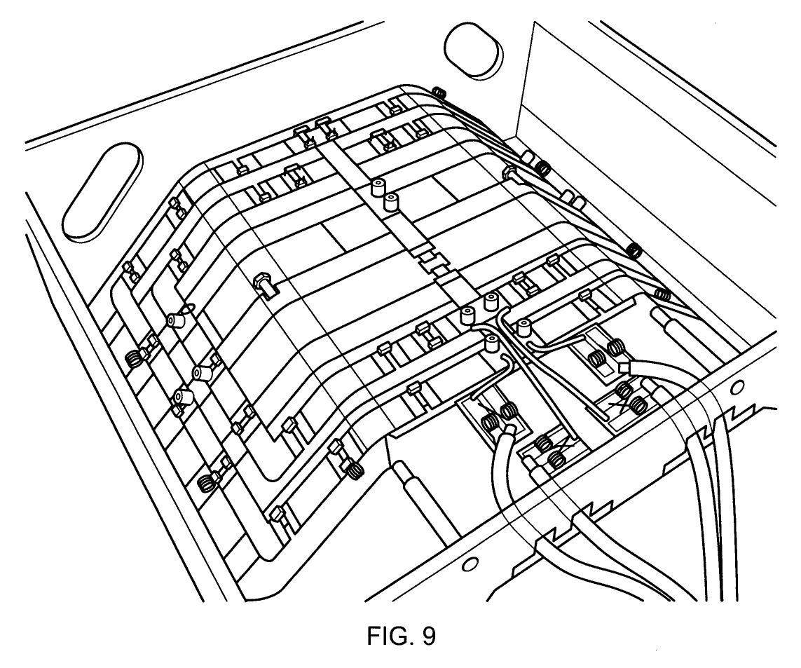

FIG. 9 shows a coil arrangement of the present invention formed on a flexible Kapton substrate, and

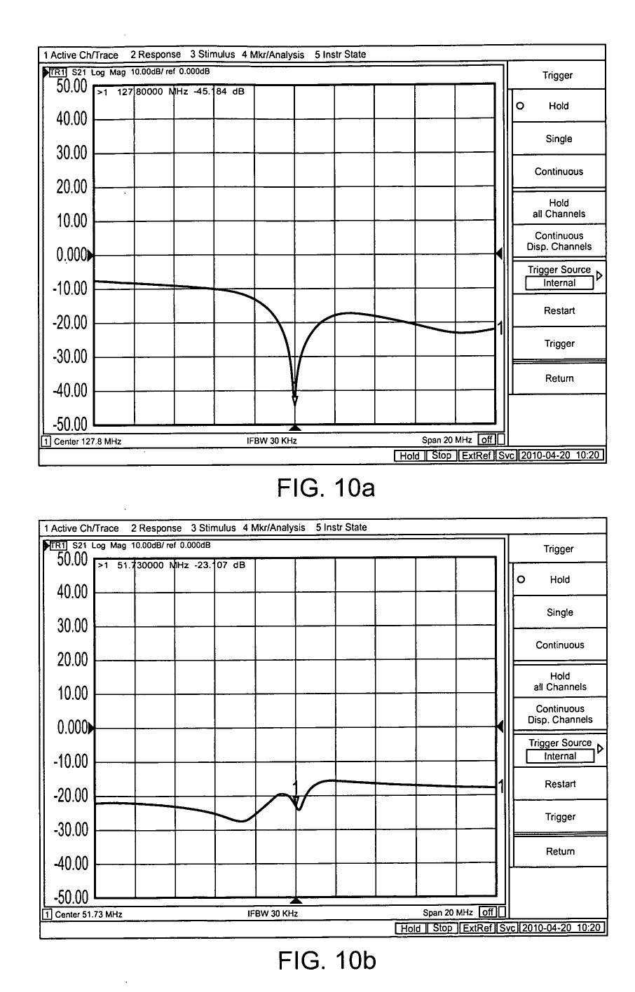

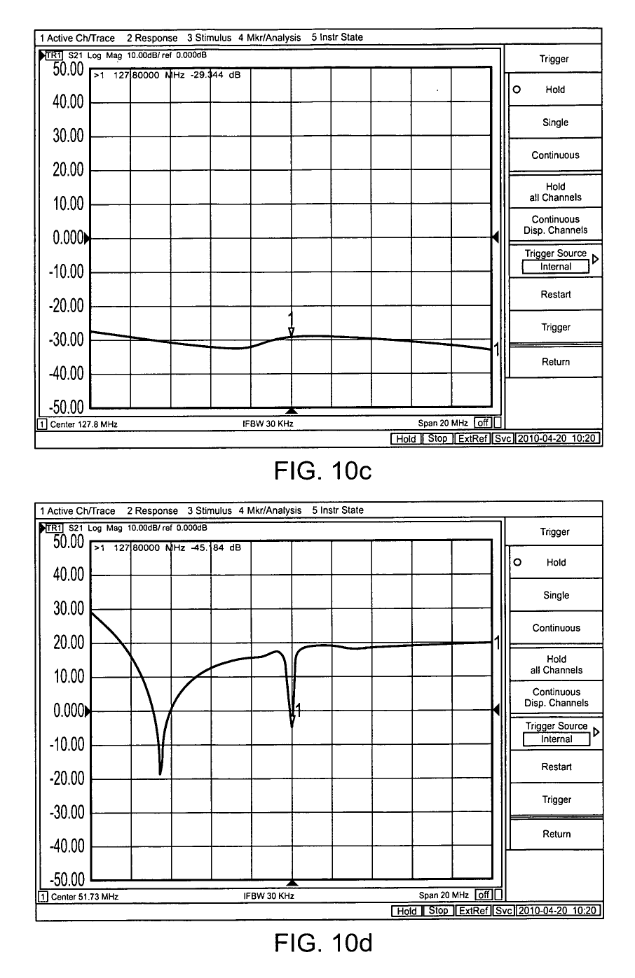

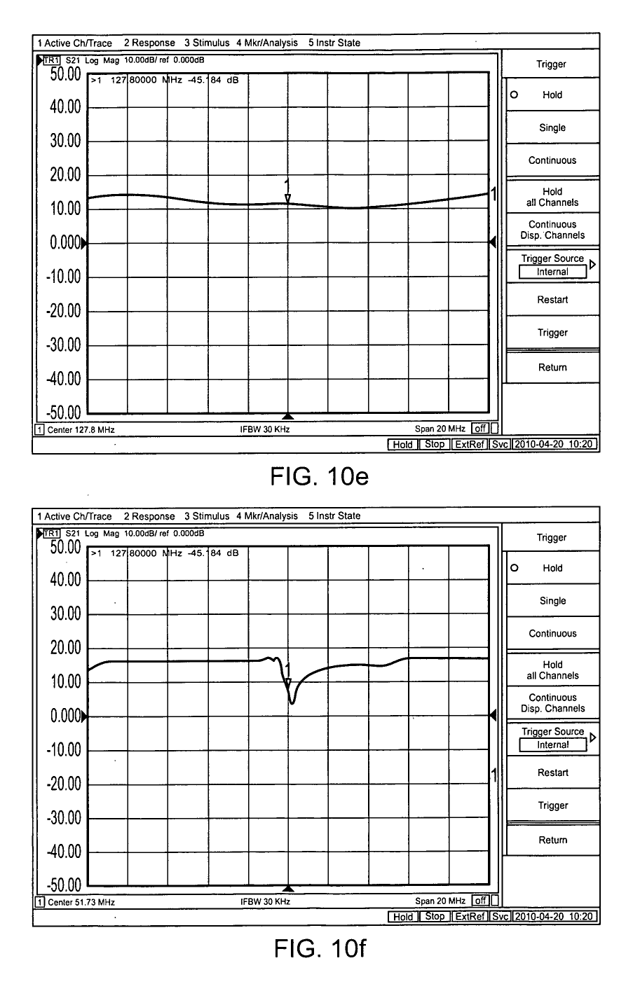

FIG. 10 shows the S21 coupling between coil elements of the apparatus shown in FIG. 9.

FIG. 1 schematically illustrates an RF coil assembly of the present invention. The coil assembly comprises an outer two-element Hydrogen (1H) coil set 2 and an inner two-element Phosphorous (31P) coil set 4. Each coil element of the 1H and 31P coil sets share a common central conductor 6. As will be explained below, such a coil geometry can be flexed when formed on a suitably flexible substrate and the coil assembly can thus be wrapped around or pressed into contact with the required part of a subject's body.

The RF coil assembly, which is described in greater detail below, is configured to produce magnetic resonance Phosphorous (31P) images from the adult human heart and liver, although it could of course be used for other targets. In use, the 1H coil set 2 is arranged to provide a so-called B₂ radiofrequency field at the 1H frequency to enhance the spectral resolution of the phosphorous signal acquired from the 31P coils. Enhancing the spectral resolution in this manner is achieved via the so-called spin spin decoupling process for removing spectral splitting. The spin spin decoupling process is known to those skilled in the art and, for brevity, will not be further described herein. The elements of the 1H coil set 2 are larger than the 31P coils to improve the decoupling coverage of the whole of the 31P sensitive region. It should also be noted that although the description will now be presented in connection with such spin spin decoupling applications, the RF coil assembly described herein could be used for any MR application where it is necessary to transmit and/or receive signals at two different frequencies. In particular, for applications where simultaneous transmit and/or receive at two different frequencies is required.

Referring to FIGS. 2 to 8, the electronics that provide an RF isolator to reduce coupling between the four RF coils of the coil assembly will be described in detail.

Referring to FIG. 2, it is shown how a pair of RF coils 20 and 22 can be electrically isolated from one another by a mutual capacitance Cd1 that is provided in series with a common central conductor 24. This has a reactance ωM where M is the mutual inductance between the adjacent coil elements 20 and 22 of the pair.

FIG. 3 shows a concentric arrangement of a pair of RF coils 22 and 30. In a similar manner to that described above with reference to FIG. 2, it is possible to isolate the RF coil elements 22 and 30 with a mutual capacitance Cd2.

FIG. 4 shows a pair of adjacent, outer, RF coil elements 20 and 22 and also a pair of adjacent, inner, RF coil elements 30 and 40. Since the mutual inductances for the adjacent and concentric coil elements will differ, when they are combined, it is not possible to isolate these four elements or loops with a single capacitor as shown in FIG. 4.

The inner (31P) coil elements and the outer (1H) coil elements operate at quite different frequencies (around 51MHz versus around 128MHz respectively). This allows RF trap circuits 50 and 52 to be used in the inner (31P) loop to minimise coil interactions from the out (1H) loop that operates at 128 MHz. The additional loss due to these traps at 51 MHz is relatively insignificant due to the dominance of loss from body tissue. The provision of such RF trap circuits 50 and 52 is shown in FIG. 5.

As shown in FIG. 6, isolation of the RF coil elements 20 and 40 (i.e. on the left hand side of the circuit) from associated RF coil elements 22 and 30 respectively (i.e. on the right hand side of the circuit) requires a single capacitive reactance for each of the above frequencies of operation. This requirement is satisfied by an LCC network 60; i.e. a first capacitor 62 and an inductor 64 in parallel that are also in series with a second capacitor 66.

The above described coil structures are resonated with suitable capacitors to allow an output impedance match to a 50 ohm transmission line. In principle this may be achieved using two-capacitor transformers as shown in FIG. 7. Here, the capacitors Ct are dominant in fixing the tuned frequency, whilst the output impedance is determined by the Cm values, providing four output ports. However, the distributed nature and finite size of the coil structure typically demands that the tuning capacitance be distributed along the conductors' length as shown FIG. 8.

FIG. 9 is a photograph of a coil of the design described above built on a flexible Kapton sheet clad with 2 oZ copper.

FIGS. 10a to 10f shows the isolation achieved between the various coil elements of the 1H and 31P coil pairs as measured using a spectrum analyser. FIG. 10a shows the isolation between two 1H elements, showing S21 is −45 dB at 127.8 MHz. FIG. 10b shows the isolation between two 31P elements; S21 is −23 dB at 51.73 MHz. FIG. 10c the isolation (−29 dB) between a 1H element and a concentric 31P element at 127.8 MHz. FIG. 10d shows the isolation (−44 dB) between a 1H element and a concentric 31P element at 51.73MHz. FIG. 10e shows the isolation (−29 dB) between a 1H element and an adjacent 31P element at 127.8 MHz. FIG. 10f shows the isolation (−31 dB) between a 1H element and an adjacent 31P element at 51.73 MHz. It can thus be seen that all coils are isolated from another by at least −20 dB.

When mechanically loaded with a first torso, the resonant frequency of the 1H elements was found to shift about 200 kHz and the resonant frequency of 31P element by about 270 kHz if the coil assembly was bent from a flat to maximum curvature position. When loaded with a second torso, the resonant frequency of the 1H elements shifted by about 290 KHz and the resonant frequency of the 31P elements by about 370 kHz when the coil was bent from a flat position to the maximum curvature position. Considering the 3 dB bandwidth of the 1H element is greater than 8 MHz and the 3 dB bandwidth of the 31P elements is greater than 2 MHz, the resonant frequency shift associated with the bending is acceptable. As a trade-off for these two extreme working positions (i.e. zero and maximum curvature), the tuning and matching were optimized when the coil was bent to half way between the flat and maximum curvature positions. In this example, the maximum curvature was 30 cm in diameter; this is equivalent to the curvature of the body above the liver.

The above described coil assembly can thus be seen to combine the advantages of quadrature phase operation with the advantages of providing a flexible substrate. This was previously not thought possible by the person skilled in the art. It should also be remembered that the above examples are merely illustrative of the present invention. The skilled person would appreciate the different ways in which RF coil assemblies could be constructed in accordance with the present invention.

1. A coil assembly for magnetic resonance apparatus, the coil assembly including a substrate comprising a first coil set and a second coil set, the first coil set including two or more coil elements that are configured to operate at a first radio frequency and the second coil set including one or more coil elements that are configured to operate at a second radio frequency, wherein the substrate is a flexible substrate and radio-frequency isolation means are provided for reducing coupling between at least some of the coil elements.

2. A coil assembly according to claim 1, wherein the first coil set comprises a pair of first coil elements that share a common central conductor, the first coil elements being operable in quadrature phase.

3. A coil assembly according to claim 2, wherein the second coil set comprises a pair of second coil elements, the second coil elements also sharing the common central conductor and being operable in quadrature phase.

4. A coil assembly according to claim 1, wherein the second coil set is located within the area of the substrate enclosed by the first coil set.

5. A coil assembly according to claim 1, wherein the first coil set and the second coil set can simultaneously operate at different radio frequencies.

6. A coil assembly according to claim 1, wherein the first coil set is configured to operate at Hydrogen (1H) frequencies.

7. A coil assembly according to claim 1, wherein the second coil set is configured to operate at Carbon (13C) or Phosphorous (31P) frequencies.

8. A coil assembly according to claim 1, wherein each of the first coil set and the second coil set can operate in a transmit and/or a receive mode.

9. A coil assembly according to claim 1, wherein the radio-frequency isolation means reduce coupling between coil elements even when the substrate is flexed into different configurations.

10. A coil assembly according to claim 9, wherein the radio-frequency isolation means provides isolation between the coils elements better than −10 db.

11. A coil assembly according to claim 1, wherein the radio-frequency isolation means comprises at least one RF trap for reducing coupling between coil elements of the first coil set and the second coil set.

12. A coil assembly according to claim 1, wherein the radio-frequency isolation means comprises a dual tuned isolation network for reducing coupling between coil elements within each of the first coil set and the second coil set.

13. A coil assembly according to claim 1, wherein the flexible substrate is formed from a insulating plastic material.

14. A coil assembly according to claim 1, that is configured for use in spin spin decoupled MR imaging or spectroscopy.

15. Magnetic resonance apparatus, comprising a coil assembly according to claim 1.

16. A coil assembly for magnetic resonance apparatus, the coil assembly comprising a substrate comprising a first coil set and a second coil set, the first coil set including two or more coil elements that are configured to operate at a first radio frequency and the second coil set including one or more coil elements that are configured to operate at a second radio frequency, wherein a non-geometric radio-frequency isolation device is provided for reducing coupling between at least some of the coil elements.

17. A coil assembly for magnetic resonance apparatus, the coil assembly comprising a flexible substrate comprising a first coil set and a second coil set, the first coil set including one or more coil elements that are configured to operate at a first radio frequency and the second coil set including one or more coil elements that are configured to operate at a second radio frequency, wherein a non-geometric radio-frequency isolation device is provided for reducing coupling between at least some of the coil elements.

18. A coil assembly for magnetic resonance apparatus, the coil assembly comprising a flexible substrate comprising a first coil set and a second coil set, the first coil set including two or more coil elements that are configured to operate at a first radio frequency and the second coil set including one or more coil elements that are configured to operate at a second radio frequency, wherein radio-frequency isolation apparatus is provided for reducing coupling between at least some of the coil elements.

19. (canceled)
